(19) United States
(12) Patent Application Publication
(10) Pub. No.: US 2026/0270631 A1
(43) Pub. Date: Sep. 10, 2026

(54) AUDIO ASSEMBLY FOR A HEARING DEVICE

(71) Applicant: Sonion Nederland B.V., Hoofddorp (NL)

(72) Inventors: Aster Marja KATOEN, Hoofddorp (NL); Dion lvo DE ROO, Hoofddorp (NL); Raymond MÖGELIN, Hoofddorp (NL)

(73) Assignee: Sonion Nederland B.V., Hoofddorp (NL)

(21) Appl. No.: 19/167,759

(22) PCT Filed: Mar. 26, 2024
(86) PCT No.: PCT/EP2024/058093

§ 371 Date: Sep. 22, 2025

(30) Foreign Application Priority Data
Apr. 4, 2023 (EP) 23166438.4

(51) Int. Cl. H04R 25/00; H04R 1/10; H04R 25/02

(52) U.S. Cl. CPC H04R 25/656; H04R 1/1016; H04R 25/02; H04R 25/48; H04R 25/604; H04R 2201/003; H04R 2225/025; H04R 2460/11

(57) ABSTRACT

The present invention relates to an audio assembly for a hearing device, said audio assembly comprising a nozzle comprising a sound channel and a sound port acoustically connected to the sound channel, wherein the sound channel has a longitudinal axis, a receiver at least partly positioned in the sound channel of the nozzle, wherein the receiver has a longitudinal axis, and wherein a housing of the receiver comprises a sound output port, and a first microphone at least partly arranged in the nozzle, wherein the first microphone comprises a sound inlet port. The longitudinal axes of the sound channel and the receiver are essentially parallel when the receiver is at least partly positioned in the sound channel. Moreover, an acoustic passage defining an acoustic mass exists between a part of a sound channel wall and an outer housing part of the receiver, and the acoustic passage extends in the direction of the longitudinal axis of the sound channel, and the acoustic passage is acoustically connected to the sound port of the nozzle and to the sound output port of the receiver whereby the acoustic passage is arranged between the sound port of the nozzle and the sound output port of the receiver. The receiver may comprise a hinged diaphragm and a voice coil secured thereto, and the hinged diaphragm is adapted to deflect in response to a drive signal applied to the voice coil. The present invention also relates to a hearing device comprising an audio assembly.

### FIELD OF THE INVENTION

The present invention relates to an audio assembly comprising a nozzle, a receiver and one or more microphones wherein the receiver and the one or more microphones are at least partly arranged in the nozzle in order to provide a small and compact audio assembly for a hearing device.

### BACKGROUND OF THE INVENTION

Within the hearing aid industry, the shape and dimensions of the hearing aid components forming the hearing aid devices are of great importance as these components need to fit into the hearing devices, such as hearing devices being at least partly positioned in the ear canal of the user of the hearing device. A typical hearing device may comprise at least one microphone configured for detecting audio sound and converting this audio sound into an electric signal. The typical hearing device may further comprise at least one receiver for regenerating an audio representation of the detected audio sound by applying an electric drive signal to the receiver. In the hearing aid industry, the term “receiver” is commonly used to refer to a sound generating device, i.e. a speaker.

Earbuds to be used with for example mobile phones (for listening to music or for making phone calls) are advantageous in that mobile phones are, due to the earbuds, not required to be held close to the ear. Typically, the earbuds fit in the concha of the ear such that sound from the outside of the ear, for example traffic noise, may by-pass the earbuds into the ear canal. This ‘open’ configuration is advantageous for people who are not hearing-impaired. It is important to note that receivers (speakers) typically used in earbuds are less size constrained and more robust against shock, for example if an earbud is dropped on the floor. Therefore, voice coil receivers are typically used in earbuds.

With respect to hearing devices, the shape and dimensions of the sound generating receiver is of particular importance. Moreover, if other components are to be arranged with the sound generating receiver the mutual arrangement of these components and the sound generating receiver is important and should thus be optimized in order to save space.

In conventional designs of voice coil receivers (also referred to as moving coil receivers) the small diaphragm sizes are, in general, associated with relatively large driving amplitudes, which in combination frequently triggers problems involving rocking modes. Since the amplitude of the tilting motion scales with voice coil excursion, and since the air gaps for the voice coil are narrow for efficiency reasons, the voice coil will at a certain level collide with the magnet causing excessive impulsive distortion due to rubbing. The rubbing of the voice coil along the air gap wall also quickly breaks the coatings of the voice coil wire and can thus cause the receiver to fail. Thus, the risk of rocking modes imposes strong limitations of usable output and lifetime of conventional voice coil receivers. This may also be one of the reasons that the size of voice coil receivers is typically significantly larger than the size of other types of receivers, such as balanced armature receivers. According to Knowles Corporation, the volume of the world's smallest commercially available voice coil receiver is still more than twice the volume of a typical balanced armature receiver.

Requirements for hearing devices, i.e. for hearing-impaired users, are much more demanding than earbuds for users who are not hearing-impaired, such as non-hearing impaired mobile phone users. Receivers typically used in hearing devices may be so-called balanced armature receivers. Balanced armature-based receivers and moving coil based receivers use different technology principles for generating sound pressure and they differ significantly in construction. The armature (a metal strip) in a balanced armature receiver is placed between two magnets and a fixed, non-moving, coil is placed around the armature. The armature tip is positioned exactly in the centre between two magnets (balanced armature). Current through the fixed coil will generate a magnetic flux in the armature, setting it in motion. A drive pin connected to one end of the armature moves a diaphragm (also connected to the drive pin) thereby producing audio sound which is let out via a sound outlet.

Balanced armature drivers offer substantially more output per volume (mm³) and are more efficient in transforming electrical energy into audio sound. This means that balanced armature receivers are inherently smaller and use less power for the same or higher sound output, i.e. for same or higher Sound Pressure Level (SPL) in dB.

Despite the many advantages of balanced armature receivers as compared with moving coil receivers, there are also some disadvantages. Balanced armatures are more sensitive to mechanical shock than moving coil receivers. With receivers being one of the more shock sensitive components in hearing aids, there is a desire to improve shock resistance. Also, the sound output of a balanced armature receiver is inherently non-linear with increasing voltage of the electrical signal used to drive the balanced armature receiver, whereas the sound output of a moving coil receiver is inherently linear with increasing voltage of the electrical signal used to drive the moving coil receiver. A linear response is advantageous for example if the hearing aid includes advanced signal processing features such as Active Noise Cancelling (ANC). Furthermore, due to a lower distortion, the sound quality of moving coil receivers is generally better, resulting in a better user experience when listening to music. A moving coil receiver is also generally easier to manufacture and contains less components as compared with a balanced armature receiver.

It may be seen as an object of embodiments of the present invention to provide a small and compact audio assembly for hearing devices comprising both a sound generating receiver and a microphone.

It may also be seen as an object of embodiments of the present invention to provide an audio assembly for hearing devices having a favourable form factor, i.e. high fit-rate, in order to ease positioning of the audio assembly in the ear canal of the user.

A relatively new category of hearing devices includes hearing devices for the so-called OTC (over-the-counter) market. These devices may include a housing (positioned in the concha of the ear) containing a receiver, a microphone and a nozzle (with a dome attached to the nozzle) positioned in the ear canal. In this way, the space available for the receiver and microphone is less limiting and the nozzle, and dome attached to the nozzle, cause the ear canal to be closed, or at least less open, to prevent leakage of sound output from the receiver. In this way, more sound output is available to overcome the hearing impairment of the wearer.

It would be desirable to further improve an audio assembly for a hearing device, such as an audio assembly for a hearing device comprising a housing to be positioned, at least in part, in the concha of an ear, and a nozzle to be positioned, at least in part, in the ear canal of the ear, in particular the lateral part of the ear canal also referred to as cartilaginous (or membranous) external acoustic meatus.

US 2013/050184 A1 relates to a hearing aid comprising an earpiece for mounting into the ear canal and a dome. The earpiece comprises a speaker unit comprising a receiver unit and a microphone unit wherein the microphone inlet and the receiver outlet are separated by a wall such that the inlet and the outlet are separated all the way into the ear canal. The speaker unit further comprises a tip on which a dome may be mounted with a speaker unit interface. EP 3 806 495 B1 relates to a hearing device, such as a receiver in canal assembly or an ear bud with optical sensors. The hearing device is to be positioned in or at the ear canal of a user. The focus of this patent specification is how to include optical sensors for measuring physiological parameters into a hearing device. Some embodiments of an earbud described in EP 3 806 495 B1 depict a speaker in a nozzle portion of the ear bud.

WO 2017/023634 A1 relates to an in-ear earbud system, such as an in-ear headphone. The in-ear headphone may comprise a transducer such as a moving coil transducer and a microphone at the distal end of the earbud, in front of the transducer.

### DESCRIPTION OF THE INVENTION

To comply with the above-mentioned objects the present invention relates, in a first aspect, to an audio assembly for a hearing device, said audio assembly comprising
1) a nozzle comprising a sound channel and a sound port acoustically connected to the sound channel, wherein the sound channel has a longitudinal axis,
2) a receiver at least partly positioned in the sound channel of the nozzle, wherein the receiver has a longitudinal axis, and wherein a housing of the receiver comprises a sound output port, and
3) a first microphone at least partly arranged in the nozzle, wherein the first microphone comprises a sound inlet port,
   wherein the longitudinal axes of the sound channel and the receiver are essentially parallel when the receiver is at least partly positioned in the sound channel, and
   wherein an acoustic passage defining an acoustic mass exists between a part of a sound channel wall and an outer housing part of the receiver, and wherein the acoustic passage extends in the direction of the longitudinal axis of the sound channel, and
   wherein the acoustic passage is acoustically connected to the sound port of the nozzle and to the sound output port of the receiver whereby the acoustic passage is arranged between the sound port of the nozzle and the sound output port of the receiver.

The audio assembly according to the first aspect is advantageous due to its small, compact and form factor friendly layout where the receiver and the microphone are arranged in the nozzle in a space saving manner where for example the acoustic passage is formed between a part of a sound channel wall and an outer housing part of the receiver.

In the present context audio assembly is to be understood as a collection of audio components arranged in a nozzle. More particularly, the audio components involve a receiver for generating and reproducing audio sound, and a first microphone for detecting audio sound. The target frequency range of both the receiver and the first microphone may be the audio frequency range between 20 Hz and 20 kHz.

In the hearing aid industry, the term receiver is commonly used to refer to a sound generating receiver, i.e. a speaker. The dimensions of the receiver to be used in the audio assembly according to the invention are typically 8×6×4 mm or smaller, preferably 7×3.5×2 mm or smaller, even more preferably 6×3×1.5 mm or smaller. Receivers to be used in the audio assembly according to the invention may also be referred to in this description as miniature receivers. The dimensions of the microphone to be used in the audio assembly according to the invention are typically 3.5×2.5×1.3 mm or smaller, preferably 3.5×2.5×1 mm or smaller, even more preferably 2.8×1.9×0.8 mm or smaller. Microphones to be used in the audio assembly according to the invention may also be referred to in this description as miniature microphones.

As stated, an acoustic passage defining an acoustic mass exists between a part of a sound channel wall and an outer housing part of the receiver. The acoustic passage extends in the direction of the longitudinal axis of the sound channel of the nozzle. Thus, in a cross-sectional plane essentially perpendicular to the longitudinal axes of the sound channel and the receiver the acoustic passage may be defined by a difference between the cross-sectional area of the sound channel, A_{N}, and the cross-sectional area of the receiver, A_{R}. In other words, the sound channel has, in a plane essentially perpendicular to a longitudinal axis of the sound channel, a cross-sectional area, A_{N}, which is limited by a sound channel wall. Similarly, the receiver has, in a plane essentially perpendicular to a longitudinal axis of the receiver, a cross-sectional area, A_{R}, defined by the housing of the receiver. The cross-sectional area, A_{N}, of the sound channel exceeds the cross-sectional area, A_{R}, of the receiver, and the excess cross-sectional area of the sound channel forms the acoustic passage.

The audio assembly may form part of a hearing device, such as a hearing aid. In particular, the audio assembly may be adapted to be positioned at least partly in the ear canal of the user of the hearing aid.

At least part of the sound port of the nozzle may form a sound inlet for the first microphone. In this embodiment, both (i) audio sound generated by the receiver, leaving the sound channel of the nozzle, and (ii) audio sound entering the sound channel in order to be detected by the first microphone cross the sound port of the nozzle-though in opposite directions. The sound inlet part of the sound port of the nozzle may be acoustically connected to the sound inlet port of the first microphone.

The receiver and the first microphone may be distinct and separate self-contained MEMS devices that may be operated independently. The first microphone may be at least partly arranged in the housing of the receiver. This arrangement may be advantageous as it may save valuable space. The first microphone and the receiver may share a common contact panel, such as a common PCB, that may comprise connection pads associated with both the first microphone and the receiver. Also, this arrangement may save valuable space.

In another space saving arrangement, the housing of the receiver may comprise a depression, indentation, recess or pocket adapted to receive at least part of the first microphone, i.e. the first microphone may be at least partly arranged in said depression, indentation, recess or pocket.

In one embodiment, the first microphone may be at least partly positioned in the acoustic passage. In this embodiment, at least part of the sound port of the nozzle may form a sound inlet which is acoustically connected to the sound inlet port of the first microphone.

The audio assembly may further comprise a second microphone comprising a sound inlet port. At least part of the sound port of the nozzle may form a sound inlet for the second microphone. Thus, both audio sound generated by the receiver, and thus leaving sound channel of the nozzle, as well as audio sound entering the sound channel in order to be detected by the first and/or second microphone crosses the sound port of the nozzle though in opposite directions. The sound inlet part of the sound port may be acoustically connected to the sound inlet port of the second microphone.

The first microphone may be adapted to measure sound pressure in the acoustic passage, and the second microphone may be adapted to measure sound pressure in the ear canal.

The receiver and the first and/or second microphones may be distinct and separate self-contained MEMS devices that may be operated independently. In order to provide a space saving arrangement, the first and/or the second microphone may be at least partly arranged in the housing of the receiver. As already mentioned, that arrangement may be advantageous as it may save valuable space. The first and/or second microphones and the receiver may share a common contact panel, such as a common PCB, that may comprise connection pads associated with both the first and/or second microphones and the receiver. Also this arrangement may save valuable space.

The receiver may have an oblong shape along its longitudinal axis. Thus, the receiver may be significantly longer along its longitudinal axis compared to any other dimensions, such as the receiver's width and/or height. The length of the receiver may thus be for example twice the width and/or height of the receiver. The sound output port of the receiver may be arranged in a first oblong housing part being essentially parallel to the longitudinal axis of the receiver. Moreover, a venting opening of the receiver may be arranged in a second oblong housing part being essentially parallel to the longitudinal axis of the receiver. The venting opening may be adapted to vent a rear volume of the receiver.

The venting opening may be designed to have specific audio properties. Thus, the venting opening may comprise an acoustic filter element forming an acoustic filter having an acoustic resistance, such as an acoustic low-pass filter having an acoustic resistance in the range of 1-5 GPa·s/m³. Similarly, the acoustic mass of the acoustic passage may be in the range 8000-30000 kg/m⁴, such as in the range 10000-25000 kg/m⁴.

The receiver may be implemented in various ways without departing from the present invention. However, preferably the receiver may comprise a hinged diaphragm and a voice coil secured thereto. The hinged diaphragm may be adapted to deflect in response to a drive signal applied to the voice coil.

The receiver housing is typically elongated, such as oblong, and the diaphragm is typically elongated, such as oblong, as well. Preferably, the diaphragm comprises a hinged diaphragm arranged within the elongated, oblong, housing. The hinged diaphragm comprises a hinged portion and a moveable portion, wherein at least the moveable portion of the diaphragm is configured to vibrate in response to the drive signal. In this preferred embodiment, the voice coil is secured to the moveable portion of the diaphragm, preferably at a distance from the hinged portion. Preferably, the hinged diaphragm is substantially rectangular and the diaphragm is hinged on one side of the substantially rectangular diaphragm, more preferably a short end of the substantially rectangular diaphragm. Preferably the voice coil is positioned such that at least part of the outer perimeter of the voice coil is positioned substantially at the end opposite the end where the diaphragm is hinged. Preferably, the voice coil extends in a direction essentially perpendicular to the diaphragm. A magnetic motor is arranged within the receiver housing, wherein the magnetic motor is adapted to generate a static magnetic field in an air gap within which at least part of the voice coil is positioned.

The term “hinged diaphragm” should be understood as a diaphragm that is hinged to for example a frame structure. The hinging of the diaphragm to for example a frame structure may be arranged in various ways, such as by applying one or more integrated hinges, applying one or more distinct and separate hinges and/or one or more film-based hinges.

The hinged diaphragm separates a front volume of the receiver from a rear volume of the receiver. The voice coil is secured to the diaphragm and positioned in the rear volume. The magnetic motor is likewise positioned in the rear volume.

It has been found by the present applicants that a receiver comprising a hinged diaphragm and a voice coil secured thereto combines several advantages of conventional balanced armature and conventional voice coil receivers, such as shock resistance, inherent linear response, making the audio assembly especially suitable for ANC applications, combined with a smaller size and higher sound output. Moreover, the hinged diaphragm avoids or at least reduces rocking modes. This makes this new type of receiver especially suited for the audio assembly according to the present invention.

The first and/or second microphones may also be implemented in various ways without departing from the present invention. Thus, the first and/or second microphones may comprise a MEMS cartridge comprising a pressure sensitive membrane, said pressure sensitive membrane extending in a plane being essentially perpendicular to a plane defined by the hinged diaphragm of the receiver in order to minimize the sensitivity of first and/or second microphone to receiver induced vibrations.

In a second aspect the present invention relates to an audio assembly for a hearing device, said audio assembly comprising
1) a nozzle having a longitudinal axis and comprising a sound port,
2) a receiver at least partly positioned in the nozzle, wherein the receiver has a longitudinal axis, and wherein a housing of the receiver comprises a sound output port acoustically connected to the sound port of the nozzle, and
3) a first microphone at least partly arranged in the nozzle, wherein the first microphone comprises a sound inlet port acoustically connected to the sound port of the nozzle,
   wherein the longitudinal axes of the nozzle and the receiver are essentially parallel when the receiver is at least partly positioned in the nozzle, and
   wherein the receiver comprises a hinged diaphragm and a voice coil secured thereto, and wherein the hinged diaphragm is adapted to deflect in response to a drive signal applied to the voice coil.

The nozzle may further comprise a sound channel acoustically connected to the sound port, wherein the sound channel, in a plane essentially perpendicular to a longitudinal axis of the sound channel, may have a cross-sectional area, A_{N}, which is limited by a sound channel wall. The receiver may be at least partly positioned in the sound channel. The receiver may have, in a plane essentially perpendicular to a longitudinal axis of the receiver, a cross-sectional area, A_{R}, that may be defined by a housing of the receiver. The cross-sectional area, A_{N}, of the sound channel may exceed the cross-sectional area, A_{R}, of the receiver, and the excess cross-sectional area of the sound channel may form an acoustic passage defining an acoustic mass between a part of the sound channel wall and an outer housing part of the receiver. The acoustic passage may extend in the direction of the longitudinal axis of the nozzle, and the acoustic passage may be acoustically connected to the sound port of the nozzle and to the sound output port of the receiver whereby the acoustic passage is arranged between the sound port of the nozzle and the sound output port of the receiver.

At least part of the sound port of the nozzle may form a sound inlet for the first microphone. Thus, both audio sound generated by the receiver, leaving the sound channel of the nozzle, as well as audio sound entering the sound channel, to be detected by the first microphone, cross the sound port of the nozzle—though in opposite directions. The sound inlet part of the sound port of the nozzle may be acoustically connected to the sound inlet port of the first microphone.

The receiver and the first microphone may be distinct and separate self-contained MEMS devices that may be operated independently. The first microphone may be at least partly arranged in the housing of the receiver. This arrangement may be advantageous as it may save valuable space. The first microphone and the receiver may share a common contact panel, such as a common PCB, that may comprise connection pads associated with both the first microphone and the receiver. Also this arrangement may save valuable space.

In another space saving arrangement, the housing of the receiver may comprise a depression, indentation, recess or pocket adapted to receive at least part of the first microphone, i.e. the first microphone may be at least partly arranged in said depression, indentation, recess or pocket.

In one embodiment, the first microphone may be at least partly positioned in the acoustic passage. In this embodiment, at least part of the sound port of the nozzle may form a sound inlet which is acoustically connected to the sound inlet port of the first microphone.

The audio assembly may further comprise a second microphone comprising a sound inlet port. At least part of the sound port of the nozzle may form a sound inlet for the second microphone. Thus, both audio sound generated by the receiver, and thus leaving sound channel of the nozzle, as well as audio sound entering the sound channel in order to be detected by the first and/or second microphones cross the sound port of the nozzle-though in opposite directions. The sound inlet part of the sound port may be acoustically connected to the sound inlet port of the second microphone.

According to one embodiment, the first microphone may be adapted to measure sound pressure in the acoustic passage, and the second microphone may be adapted to measure sound pressure in the ear canal.

The receiver and the first and/or second microphones may be distinct and separate self-contained MEMS devices that may be operated independently. In order to provide a space saving arrangement the first and/or the second microphone may be at least partly arranged in the housing of the receiver. As already mentioned, that arrangement may be advantageous as it may save valuable space. The first and/or second microphones and the receiver may share a common contact panel, such as a common PCB, that may comprise connection pads associated with both the first and/or second microphones and the receiver. Also this arrangement may save valuable space.

The receiver may have an oblong shape along its longitudinal axis. Thus, the receiver may be significantly longer along its longitudinal axis compared to any other dimensions, such as the receiver's width and/or height. The length of the receiver may thus be for example twice the width and/or height of the receiver. The sound output port of the receiver may be arranged in a first oblong housing part being essentially parallel to the longitudinal axis of the receiver. Moreover, a venting opening of the receiver may be arranged in a second oblong housing part being essentially parallel to the longitudinal axis of the receiver. The venting opening may be adapted to vent a rear volume of the receiver.

The venting opening may be designed to have specific audio properties. Thus, the venting opening may comprise an acoustic filter element forming an acoustic filter having an acoustic resistance, such as an acoustic low-pass filter having an acoustic resistance in the range of 1-5 GPa·s/m³. Similarly, the acoustic mass of the acoustic passage may be in the range 8000-30000 kg/m⁴, such as in the range 10000-25000 kg/m⁴.

As already mentioned, the receiver comprises a hinged diaphragm and a voice coil secured thereto. Thus, the receiver is implemented as a so-called moving coil receiver. The hinged diaphragm is adapted to deflect in response to a drive signal applied to the voice coil. With respect to the first and/or second microphones various implementations are also applicable. Thus, the first and/or second microphones may comprise a MEMS cartridge comprising a pressure sensitive membrane, said pressure sensitive membrane extending in a plane being essentially perpendicular to a plane defined by the hinged diaphragm of the receiver in order to minimize the sensitivity of first and/or second microphone to receiver induced vibrations.

The receiver may comprise a housing with a sound outlet port and a venting opening provided therein. The venting opening may have an acoustic filter, such as a low-pass filer having an acoustic resistance in the range of 1-5 GPa·s/m³, arranged therein. Within the housing a front volume and a rear volume may be provided. These volumes may be separated by the hinged diaphragm that may comprise a hinged portion and a moveable portion, wherein at least the moveable portion of the hinged diaphragm is adapted to vibrate, and thus generate sound waves, in response to a drive signal applied to a voice coil secured to the moveable portion of the hinged diaphragm. At least part of the hinged diaphragm may comprise an embossed part for increasing the stiffness of the diaphragm and/or for providing an air venting path so that an air volume inside a magnetic motor can be properly vented. The magnetic motor, which is adapted to displace the moveable portion of the hinged diaphragm, may comprise a permanent magnet sandwiched between a centre yoke and an outer yoke. The centre yoke and the outer yoke form an air gap within which at least part of the voice coil is positioned. The hinged diaphragm may be hinged via one or more hinges to a frame structure. The hinged diaphragm and the frame structure may form an integrated structure of the same material, such as metal including aluminium. The hinged diaphragm and the frame structure may be separated by one or more openings which are at least partly filled with a flexible sealing member, such as a corrugated polymer film or a viscoelastic gel. With the flexible sealing member applied in the one or more openings between the hinged diaphragm and the frame structure, the front and rear volumes are acoustically sealed from each other, and the moveable portion of the hinged diaphragm is allowed to vibrate.

In a third aspect the present invention relates to a hearing device comprising an audio assembly according to any of the preceding aspects.

According to a preferred embodiment, the hearing device of the present invention comprises a hearing device housing configured for positioning in the concha of a user. Moreover, an audio assembly according to the invention preferably comprises a nozzle attached to the hearing device housing and configured for positioning in the ear canal, in particular the lateral part of the ear canal.

A dome, such as a flexible dome, may be attached to the nozzle of the audio assembly for positioning the nozzle in the ear canal.

In general, the various aspects of the present invention may be combined and coupled in any way possible within the scope of the invention. These and other aspects, features and/or advantages of the present invention will be apparent from and elucidated with reference to the embodiments described hereinafter.

### BRIEF DESCRIPTION OF THE DRAWINGS

The present invention will now be described with reference to the accompanying drawings wherein:

FIG. 1 shows an audio assembly comprising a receiver and a single microphone in a separate pocket,

FIG. 2 shows an audio assembly comprising a receiver and a single microphone in an acoustic passage,

FIG. 3 shows an audio assembly comprising a receiver and two microphones,

FIG. 4 shows an audio assembly comprising a receiver and two microphones in extended acoustic passages,

FIG. 5 shows an audio assembly comprising a receiver and a single microphone arranged in an indentation of the receiver,

FIG. 6 shows a receiver with a single microphone arranged in a pocket,

FIG. 7 shows a receiver with an embedded microphone,

FIG. 8 shows cross-sectional views of two receiver embodiments,

FIG. 9 shows an audio assembly comprising a receiver and a single rotated microphone, and

FIG. 10 shows an audio assembly comprising a receiver and a single rotated microphone in a pocket.

### DETAILED DESCRIPTION OF THE INVENTION

In general, the present invention relates to an audio assembly for a hearing device wherein a receiver and one or more microphones are at least partly arranged in a nozzle in order to provide a small and compact audio assembly suitably for positioning in the ear canal of a user of the hearing device.

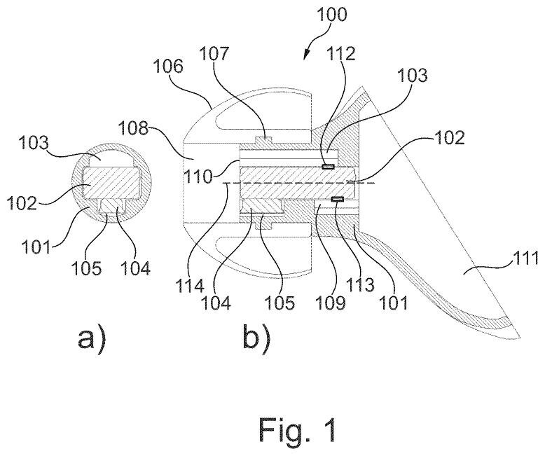

FIGS. 1-5, 9 and 10 depict various embodiments of audio assemblies of the present invention. All depicted embodiments are suitable for being used in hearing devices, such as hearing aids. The various embodiments will be disclosed independently in the following although the associated disclosures may to at least some degree be overlapping.

FIGS. 1a-b show an audio assembly 100 according to an embodiment of the present invention, where FIG. 1a is a cross-sectional view from the front of the assembly, and FIG. 1b is a cross-sectional view from the side of the assembly.

In FIG. 1b the audio assembly 100 comprises a nozzle 101 having a sound channel and a sound port 108 acoustically connected to the sound channel. The sound channel has a longitudinal axis 114 extending in the longitudinal direction in FIG. 1b. A receiver 102 is at least partly positioned in the sound channel of the nozzle 101. The receiver 102 also has a longitudinal axis that may coincide with longitudinal axis 114. The receiver 102 comprises a sound output port 112, and the receiver 102 is maintained in position via press fitting from the nozzle 101.

Moreover, a microphone 104 is at least partly arranged in a recess or pocket 105 in the nozzle 101. As depicted in FIG. 1b, the microphone 104 occupies a vast majority of the recess or pocket 105 in the longitudinal direction. The microphone 104 comprises a sound inlet port (not shown) that faces away from the receiver 102. Moreover, the microphone 104 is acoustically connected to an excess volume of the recess or pocket 105, wherein said excess volume is acoustically connected to the sound port 108 of the nozzle 101. Thus, audible sound entering the sound port 108 of the nozzle 101 can be detected by the microphone 104. In FIG. 1b an acoustic passage 103 defining an acoustic mass exists between a part of a sound channel wall and an outer housing part of the receiver 102. The acoustic passage 103 extends in the direction of the longitudinal axis of the sound channel of the nozzle 101, i.e. in the longitudinal direction in FIG. 1b. The acoustic passage 103 is, at one end, acoustically connected to the sound port of the nozzle 108 via the opening 110, and acoustically connected to the sound output port 112 of the receiver 102 at or near the other end whereby the acoustic passage 103 is arranged between the sound port of the nozzle 108 and the sound output port 112 of the receiver 102.

In FIG. 1b the audio assembly 100 further comprises a flexible dome 106 secured to the nozzle 101. The flexible dome 106, which is adapted to properly position the audio assembly in the ear canal of the user, is aligned with the nozzle 101 via the protrusion 107 which engages with a corresponding recess in the flexible dome 106. The nozzle 101 and the flexible dome 106 are fixated relative to each other via press fitting. A venting opening 113 of the receiver 102 is adapted to vent the rear volume of the receiver 102, and as seen in FIG. 1b, the venting opening 113 is acoustically connected to an external rear volume 111 via a venting channel 109 formed in the nozzle 101.

In FIG. 1a the nozzle 101, the receiver 102 and the microphone 104 are depicted from a front perspective of the audio assembly 100, i.e. from the sound port 108. In addition to the structural elements (the nozzle 101, the receiver 102, and the microphone 104) the acoustic passage 103 as well as the recess or pocket 105 are also depicted.

As it will be discussed in further details below the receiver 102 may be a moving coil type receiver where a voice coil is secured to a hinged diaphragm which is adapted to move when a drive signal is applied to the voice coil. In terms of performance the receiver 102 has a low-frequency output at 100 Hz (1 Vrms) at around 120 dB SPL, and a maximum output at the first resonance peak (around 2 kHz) at 122 dB SPL. The mechanical resonance frequency of the hinged diaphragm is around 15 kHz.

The microphone 104 may be a MEMS microphone comprising a MEMS cartridge and a signal processor for processing signals from the MEMS cartridge. The MEMS microphone may be sensitive in the audible range, i.e. between 20 Hz and 20 KHz.

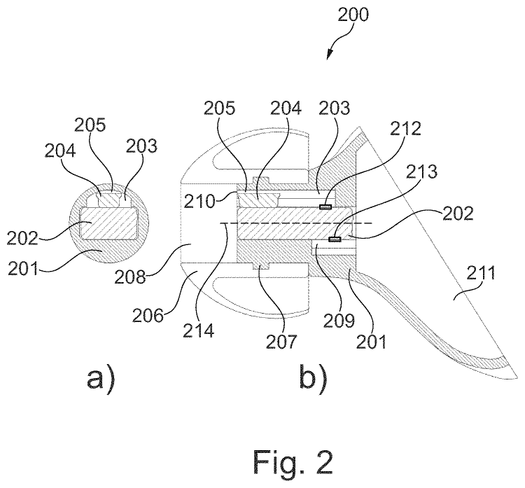

FIGS. 2a-b show an audio assembly 200 according to another embodiment of the present invention, where again FIG. 2a is a cross-sectional view from the front of the assembly, and FIG. 2b is a cross-sectional view from the side of the assembly.

As seen in FIG. 2b, the audio assembly 200 again comprises a nozzle 201 having a sound channel and a sound port 208 acoustically connected to the sound channel. The sound channel has a longitudinal axis 214 in the longitudinal direction of FIG. 2b. A receiver 202 is at least partly positioned in the sound channel of the nozzle 201. The receiver 202 has a longitudinal axis that may coincide with longitudinal axis 214, and the receiver 202 is kept in position via press fitting. The receiver 202 comprises a sound output port 212.

Moreover, a microphone 204 is at least partly arranged in the nozzle 201. The microphone 204 comprises a sound inlet port (not shown) that faces away from the receiver 202, and the microphone 204 is acoustically connected to an excess volume 205 which is acoustically connected to the sound port 208 of the nozzle 201.

In FIG. 2b an acoustic passage 203 defining an acoustic mass exists between a part of a sound channel wall and an outer housing part of the receiver 202. As seen in FIG. 2b, the microphone 204 is at least partly arranged in the acoustic passage 203, and the excess volume 205 (above the microphone 204) forms part of the acoustic passage 203 which extends in the direction of the longitudinal axis of the sound channel of the nozzle 201. The acoustic passage 203 is, at one end, acoustically connected to the sound port of the nozzle 208 via the opening 210, and acoustically connected to the sound output port 212 of the receiver 202 at or near the other end. The acoustic passage 203 thus becomes arranged between the sound port of the nozzle 208 and the sound output port 212 of the receiver 202. With respect to the positioning of the microphone 204 in the acoustic passage 203, the microphone 204 is aligned with the opening 210.

In FIG. 2b the audio assembly 200 further comprises a flexible dome 206 secured to the nozzle 201. The flexible dome 206, which is adapted to position the audio assembly in the ear canal of the user, is again aligned with the nozzle 201 via the protrusion 207 which engages with a corresponding recess in the flexible dome 206. The nozzle 201 and the flexible dome 206 are fixated relative to each other via press fitting. A venting opening 213 of the receiver 202 is adapted to vent the rear volume of the receiver 202, and as seen in FIG. 2b, the venting opening 213 is acoustically connected to an external rear volume 211 via a venting channel 209 formed in the nozzle 201.

In FIG. 2a the nozzle 201, the receiver 202 and the microphone 204 are depicted from a front perspective, i.e. from the sound port 208. In addition to the structural elements (the nozzle 201, the receiver 202, and the microphone 204) the acoustic passage 203 and the excess volume 205 are also depicted.

Again, the receiver 202 may be a moving coil type receiver where a voice coil is secured to a hinged diaphragm. In terms of performance the receiver 202 has a low-frequency output at 100 Hz (1 Vrms) at around 120 dB SPL, and a maximum output at the first resonance peak (around 2 kHz) at 122 dB SPL. The mechanical resonance frequency of the hinged diaphragm is around 15 kHz.

The microphone 204 may be a MEMS microphone comprising a MEMS cartridge and a signal processor for processing signals from the MEMS cartridge. The MEMS microphone may be sensitive in the audible range, i.e. between 20 Hz and 20 KHz.

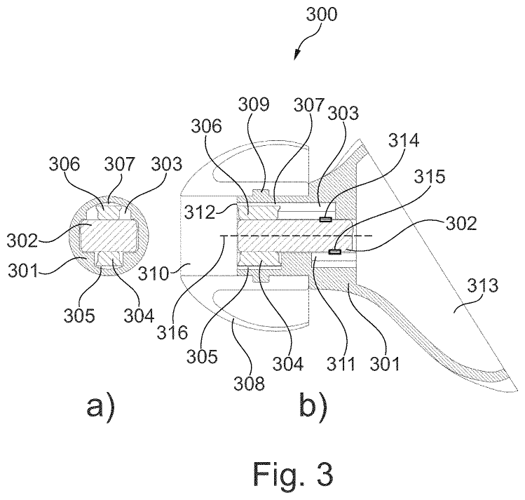

Turning now to FIGS. 3a-b, an audio assembly 300 comprising two microphones 304, 306 is depicted. Again, FIG. 3a is a cross-sectional view from the front of the audio assembly, whereas FIG. 3b is a cross-sectional view from the side of the assembly.

The audio assembly 300 according to this embodiment comprises a nozzle 301 having a sound channel and a sound port 310 acoustically connected to the sound channel. The sound channel has a longitudinal axis 316. A receiver 302 is at least partly positioned, and fixated via press fitting, in the sound channel of the nozzle 301. The receiver 302 has a longitudinal axis that may coincide with longitudinal axis 316. The receiver 302 comprises a sound output port 314.

Moreover, a first microphone 304 is at least partly arranged in a recess or pocket 305 in the nozzle 301. As depicted in FIG. 3b, the first microphone 304 occupies a vast majority of the recess or pocket 305. The first microphone 304 comprises a sound inlet port (not shown) that faces away (downwards) from the receiver 302, and the sound inlet port of the first microphone 304 is acoustically connected to the recess or pocket 305 which is acoustically connected to the sound port 310 of the nozzle 301. Thus, the first microphone 304 is capable of detecting audible sound that enters the sound port 310 of the nozzle 301.

Moreover, a second microphone 306 is at least partly arranged in the nozzle 301. The second microphone 306 also comprises a sound inlet port (not shown) that faces away (upwards) from the receiver 302. The sound inlet port is acoustically connected to an excess volume 307 which is acoustically connected to the sound port 310 of the nozzle 301. Thus, also the second microphone 306 is capable of detecting audible sound that enters the sound port 310 of the nozzle 301.

As seen in FIG. 3b, an acoustic passage 303 defining an acoustic mass exists between a part of a sound channel wall and an outer housing part of the receiver 302. The second microphone 306 is at least partly arranged in the acoustic passage 303, and the excess volume 307 (above the second microphone 306) forms part of the acoustic passage 303 which extends in the direction of the longitudinal axis of the sound channel of the nozzle 301. The acoustic passage 303 is acoustically connected, at one end, to the sound port of the nozzle 310 via the opening 312, and acoustically connected to the sound output port 314 of the receiver 302 at or near the other end. The acoustic passage 303 thus becomes arranged between the sound port of the nozzle 310 and the sound output port 314 of the receiver 302. The microphone 306 is arranged in the acoustic passage 303 so that it is aligned with the opening 312.

Still referring to FIG. 3b the audio assembly 300 further comprises a flexible dome 308 secured to the nozzle 301. The flexible dome 308, which is adapted to position the audio assembly in the ear canal of the user, is aligned with the nozzle 301 via the protrusion 309 which engages with a corresponding recess in the flexible dome 308. The nozzle 301 and the flexible dome 308 are fixated relative to each other via press fitting. A venting opening 315 of the receiver 302 is adapted to vent the rear volume of the receiver 302, and as seen in FIG. 3b, the venting opening 315 is acoustically connected to an external rear volume 313 via a venting channel 311 formed in the nozzle 301.

In FIG. 3a the nozzle 301, the receiver 302 and the first and second microphones 304, 306 are depicted from a front perspective, i.e. from the sound port 310. In addition to the structural elements (the nozzle 301, the receiver 302, and the microphones 304, 306) the acoustic passage 303, the recess or pocket 305 and the excess volume 307 are also depicted. Again, the receiver 302 may be a moving coil type receiver where a voice coil is secured to a hinged diaphragm. In terms of performance the receiver 302 has a low-frequency output at 100 Hz (1 Vrms) at around 120 dB SPL, and a maximum output at the first resonance peak (around 2 kHz) at 122 dB SPL. The mechanical resonance frequency of the hinged diaphragm is around 15 kHz.

The first and second microphones 304, 306 may be a MEMS microphone comprising a MEMS cartridge and a signal processor for processing signals from the MEMS cartridge. The MEMS microphone may be sensitive in the audible range, i.e. between 20 Hz and 20 KHz.

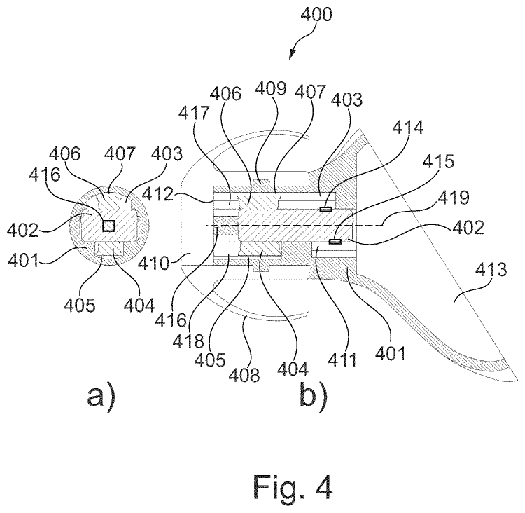

The embodiment of FIGS. 4a-b is very similar to the embodiment depicted in FIGS. 3a-b. In fact the only difference is the extended length of the acoustic passage 403.

Thus, FIGS. 4a-b also show an audio assembly 400 comprising two microphones 404, 406. Again, FIG. 4a is a cross-sectional view from the front of the audio assembly 400, whereas FIG. 4b is a cross-sectional view from the side of the audio assembly 400.

The audio assembly 400 according to this embodiment comprises a nozzle 401 having an extended sound channel and a sound port 410 acoustically connected to the extended sound channel. The extended sound channel has a longitudinal axis 419. A receiver 402 is at least partly positioned, and fixated via press fitting, in the extended sound channel of the nozzle 401. The receiver 402, which has a longitudinal axis that may coincide with longitudinal axis 419, is arranged against, and thus abuts, the nozzle element 416 which acts as a mechanical stop. The receiver 402 comprises a sound output port 414.

Moreover, a first microphone 404 is at least partly arranged in a recess or pocket 418 in the nozzle 401. As depicted in FIG. 4b, the first microphone 404 occupies one end of the recess or pocket 418. The first microphone 404 comprises a sound inlet port (not shown) that faces away (downwards) from the receiver 402, and the sound inlet port of the first microphone 404 is acoustically connected to the recess or pocket 418 via an excess volume 405. The recess or pocket 418 is acoustically connected to the sound port 410 of the nozzle 401. Thus, the first microphone 404 is capable of detecting audible sound that enters the sound port 410 of the nozzle 401.

Moreover, a second microphone 406 is at least partly arranged in the nozzle 401. The second microphone 406 also comprises a sound inlet port (not shown) that faces away (upwards) from the receiver 402. The sound inlet port is acoustically connected to an excess volume 307 which is acoustically connected to the sound port 410 of the nozzle 401 via part 417 of an acoustic passage 403. Thus, also the second microphone 306 is capable of detecting audible sound that enters the sound port 410 of the nozzle 401.

As seen in FIG. 4b, an acoustic passage 403, 417 defining an acoustic mass exists between a part of a sound channel wall and an outer housing part of the receiver 402 or the nozzle element 416. The second microphone 406 is at least partly arranged in the acoustic passage 403, 417, and the excess volume 407 (above the second microphone 406) forms part of the acoustic passage 403, 417 which extends in the direction of the longitudinal axis of the sound channel of the nozzle 401. The acoustic passage 403, 417 is acoustically connected, at one end, to the sound port of the nozzle 410 via the opening 412, and acoustically connected to the sound output port 414 of the receiver 402 at or near the other end. The acoustic passage 403, 417 thus becomes arranged between the sound port of the nozzle 410 and the sound output port 414 of the receiver 402.

Still referring to FIG. 4b the audio assembly 400 further comprises a flexible dome 408 secured to the nozzle 401. The flexible dome 408, which is adapted to position the audio assembly in the ear canal of the user, is aligned with the nozzle 401 via the protrusion 409 which engages with a corresponding recess in the flexible dome 408. The nozzle 401 and the flexible dome 408 are fixated relative to each other via press fitting. A venting opening 415 of the receiver 402 is adapted to vent the rear volume of the receiver 402, and as seen in FIG. 4b, the venting opening 415 is acoustically connected to an external rear volume 413 via a venting channel 411 formed in the nozzle 401.

In FIG. 4a the nozzle 401, the receiver 402 and the first and second microphones 404, 406 are depicted from a front perspective, i.e. from the sound port 410. In addition to the structural elements (the nozzle 401, the receiver 402, and the microphones 404, 406) the acoustic passage 403, the recess or pocket 418 and the acoustic passage 417 are also depicted.

Again, the receiver 402 may be a moving coil type receiver where a voice coil is secured to a hinged diaphragm. In terms of performance the receiver 402 has a low-frequency output at 100 Hz (1 Vrms) at around 120 dB SPL, and a maximum output at the first resonance peak (around 2 kHz) at 122 dB SPL. The mechanical resonance frequency of the hinged diaphragm is around 15 kHz. The first and second microphones 404, 406 may be a MEMS microphone comprising a MEMS cartridge and a signal processor for processing signals from the MEMS cartridge. The MEMS microphone may be sensitive in the audible range, i.e. between 20 Hz and 20 KHz.

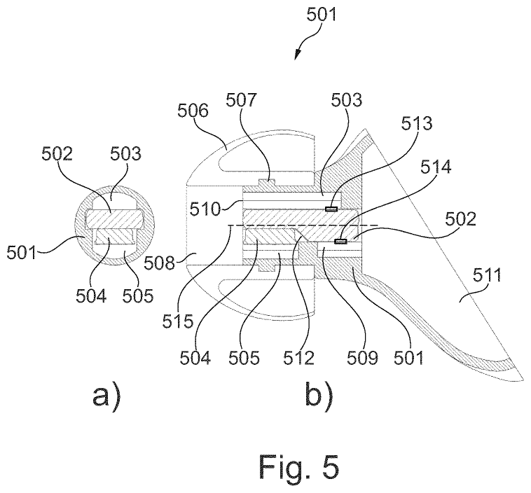

The embodiment of FIGS. 5a-b show an audio assembly 5100 comprising a receiver 502 having an indentation 512 in the form of a narrow or thin receiver portion in order to provide space for a microphone 504. Similar to the previous embodiments, FIG. 5a is a cross-sectional view from the front of the assembly 500, whereas FIG. 5b is a cross-sectional view from the side of the audio assembly 500.

Thus, in FIG. 5b the audio assembly 500 comprises a nozzle 501 having a sound channel and a sound port 508 acoustically connected to the sound channel. The sound channel has a longitudinal axis 515 extending in the longitudinal direction in FIG. 5b. A receiver 502 is at least partly positioned in the sound channel of the nozzle 501. The receiver 502 has a longitudinal axis that may coincide with longitudinal axis 515. The receiver 502 comprises a sound output port 513, and the receiver 502 is maintained in position via press fitting from the nozzle 501. The receiver 502 further comprises an indentation 512 in the form of a narrow or thin receiver portion in order to provide space for a microphone 504 at least partly arranged in that indentation 512.

Moreover, the microphone 504 is at least partly arranged in a recess or pocket 505 in the nozzle 501. As depicted in FIG. 5b, the microphone 504 occupies a vast majority of the recess or pocket 505 in the longitudinal direction. The microphone 504 comprises a sound inlet port (not shown) that faces away from the receiver 502. Moreover, the microphone 504 is acoustically connected to an excess volume of the recess or pocket 505, wherein said excess volume is acoustically connected to the sound port 508 of the nozzle 501. Thus, audible sound that enters the sound port 508 of the nozzle 501 can be detected by the microphone 504.

In FIG. 5b, an acoustic passage 503 defining an acoustic mass exists between a part of a sound channel wall and an outer housing part of the receiver 502. The acoustic passage 503 extends in the direction of the longitudinal axis of the sound channel of the nozzle 501, i.e. in the longitudinal direction in FIG. 5b. The acoustic passage 503 is, at one end, acoustically connected to the sound port of the nozzle 508 via the opening 510, and acoustically connected to the sound output port 513 of the receiver 502 at or near the other end. The acoustic passage 503 thus becomes arranged between the sound port of the nozzle 508 and the sound output port 513 of the receiver 502.

In FIG. 5b the audio assembly 500 further comprises a flexible dome 506 secured to the nozzle 501. The flexible dome 506, which is adapted to properly position the audio assembly in the ear canal of the user, is aligned with the nozzle 501 via the protrusion 507 which engages with a corresponding recess in the flexible dome 506. The nozzle 501 and the flexible dome 506 are fixated relative to each other via press fitting. A venting opening 514 of the receiver 502 is adapted to vent the rear volume of the receiver 502, and as seen in FIG. 5b, the venting opening 514 is acoustically connected to an external rear volume 511 via a venting channel 509 formed in the nozzle 501.

In FIG. 5a the nozzle 501, the receiver 502 and the microphone 504 are depicted from a front perspective of the audio assembly 500, i.e. from the sound port 508. In addition to the structural elements (the nozzle 501, the receiver 502, and the microphone 504) the acoustic passage 503 as well as the recess or pocket 505 are also depicted.

The receiver 502 may be a moving coil type receiver where a voice coil is secured to a hinged diaphragm which is adapted to move when a drive signal is applied to the voice coil. In terms of performance the receiver 502 has a low-frequency output at 100 Hz (1 Vrms) at around 120 dB SPL, and a maximum output at the first resonance peak (around 2 kHz) at 122 dB SPL. The mechanical resonance frequency of the hinged diaphragm is around 15 kHz. The microphone 504 may be a MEMS microphone comprising a MEMS cartridge and a signal processor for processing signals from the MEMS cartridge. The MEMS microphone may be sensitive in the audible range, i.e. between 20 Hz and 20 KHz.

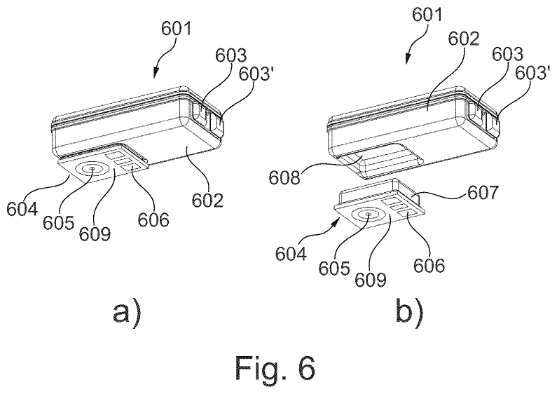

Turning now to FIGS. 6a-b, a receiver 601 with an incorporated MEMS microphone 604 is depicted. In FIG. 6a the MEMS microphone 604 is arranged in a pocket 608 of the receiver 601, whereas in FIG. 6b the MEMS microphone 604 is removed from the pocket 608 of the receiver 601. Since the MEMS microphone 604 is arranged in a pocket of the receiver 601, the MEMS microphone 604 may be a self-contained MEMS microphone, i.e. a MEMS microphone that only needs to be connected to a power source for functioning.

The receiver 601 may be a moving coil type receiver where a voice coil is secured to a hinged diaphragm which is adapted to move when a drive signal is applied to the voice coil. In terms of performance the receiver 601 has a low-frequency output at 100 Hz (1 Vrms) at around 120 dB SPL, and a maximum output at the first resonance peak (around 2 kHz) at 122 dB SPL. The mechanical resonance frequency of the hinged diaphragm is around 15 kHz. The receiver 601 is operated by providing drive signals to the terminals 603, 603′ arranged on the housing 602. The MEMS microphone 604 may comprise a MEMS cartridge and a signal processor for processing signals from the MEMS cartridge. The MEMS microphone, that may be sensitive in the audible range, i.e. between 20 Hz and 20 kHz, comprises a sound inlet port 605 and electrical terminals 606 for contacting the MEMS microphone 604 to surrounding devices, such as a power supply, a signal processor etc. The sound inlet port 605 and the electrical terminals 606 may be arranged on an exterior printed circuit board (PCB) 609 that may form part of a housing of the MEMS microphone 604. A further housing part 607 may, in combination with the PCB 609, form the entire housing of the MEMS microphone 604.

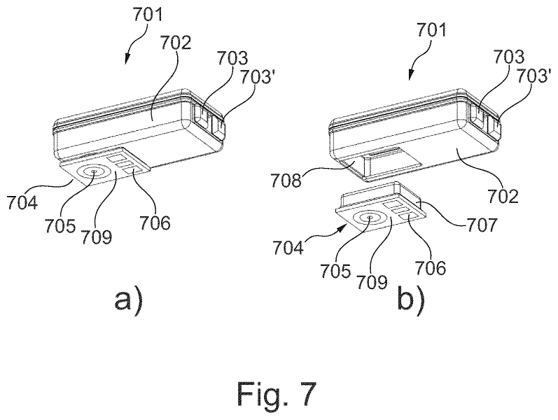

In FIGS. 7a-b, a receiver 701 with an embedded MEMS microphone 704 is depicted. In FIG. 7a the MEMS microphone 704 is embedded in the receiver 701, whereas in FIG. 7b the MEMS microphone 704 is not embedded in the receiver 701. By embedding the MEMS microphone 704 into the receiver 701, the electronic components of two devices may be arranged on the same internal PCB, and not two separate PCBs.

Again, the receiver 701 may be a moving coil type receiver where a voice coil is secured to a hinged diaphragm which is adapted to move when a drive signal is applied to the voice coil. In terms of performance the receiver 701 has a low-frequency output at 100 Hz (1 Vrms) at around 120 dB SPL, and a maximum output at the first resonance peak (around 2 kHz) at 122 dB SPL. The mechanical resonance frequency of the hinged diaphragm is around 15 kHz. The receiver 701 is operated by providing drive signals to the terminals 703, 703′ arranged on the housing 702. The MEMS microphone 704 may comprise a MEMS cartridge and a signal processor for processing signals from the MEMS cartridge. The MEMS cartridge and the signal processor may be arranged on a PCB that also functions as a PCB for components of the receiver 701. The MEMS microphone, that may be sensitive in the audible range, i.e. between 20 Hz and 20 kHz, comprises a sound inlet port 705 and electrical terminals 706 for contacting the MEMS microphone 704 to surrounding devices, such as a power supply, a signal processor etc. The sound inlet port 705 and the electrical terminals 706 may be arranged on an exterior PCB 709 that may also form part of a housing of the MEMS microphone 704. A further housing part 707 may, in combination with the PCB 709, form the entire housing of the MEMS microphone 704.

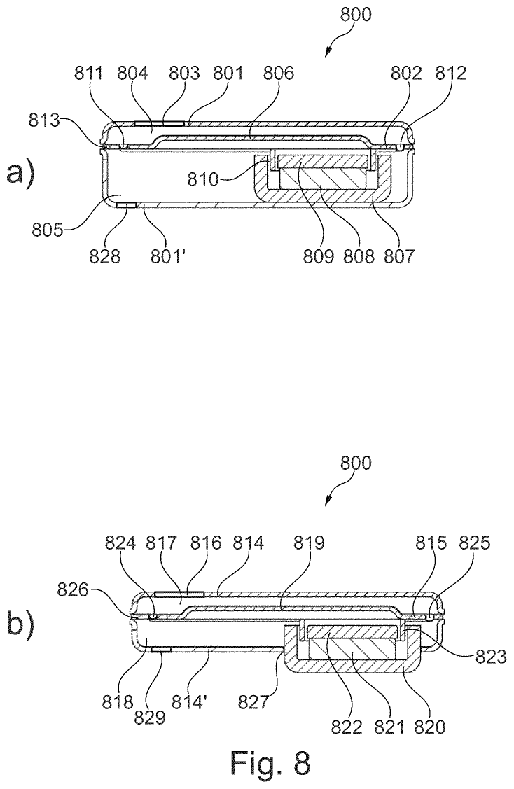

FIGS. 8a-b show embodiments of the receiver 800 of the audio assembly of the present invention. Turning to FIG. 8a the receiver 800 comprises a housing 801, 801′ with a sound outlet port 803 and a venting opening 828 arranged therein. The venting opening 828 may have an acoustic filter (not shown), such as a low-pass filer, arranged therein. Within the housing 801, 801′ a front volume 804 and a rear volume 805 are provided. These volumes 804, 805 are separated by the hinged diaphragm 802. The hinged diaphragm 802 comprises a hinged portion and a moveable portion, wherein at least the moveable portion of the hinged diaphragm 802 is adapted to vibrate, and thus generate sound waves, in response to a drive signal applied to a voice coil 810 secured to the moveable portion of the hinged diaphragm 802. As seen in FIG. 8a, at least part of the hinged diaphragm 802 comprises an embossed part 806 for increasing the stiffness of the diaphragm and/or for providing an air venting path so that the air volume inside the magnetic motor can be vented. The magnetic motor comprises a permanent magnet 808 sandwiched between a centre yoke 809 and an outer yoke 807. The centre yoke 809 and the outer yoke 807 form an air gap within which at least part of the voice coil 810 is positioned. The hinged diaphragm 802 is hinged via one or more hinges 811 to a frame structure 813. The hinged diaphragm 802 and the frame structure 813 preferably form an integrated structure of the same material, such as metal including aluminium. The hinged diaphragm 802 and the frame structure 813 are separated by one or more openings which are at least partly filled with a flexible sealing member 812, such as a corrugated polymer film or a viscoelastic gel. With the flexible sealing member 812 applied in the one or more openings between the hinged diaphragm 802 and the frame structure 813, the front and rear volumes 804, 805 are acoustically sealed from each other.

Turning to FIG. 8b a receiver 800 with a reduced height is depicted. The receiver 800 shown in FIG. 8b comprises a housing 814, 814′ with a sound outlet port 816 and a venting opening 829 arranged therein. The venting opening 829 may have an acoustic filter (not shown), such as a low-pass filer, arranged therein. Within the housing 814, 814′ a front volume 817 and a rear volume 818 are provided. These volumes 817, 818 are again separated by the hinged diaphragm 815. The hinged diaphragm 815 comprises a hinged portion and a moveable portion, wherein at least the moveable portion of the hinged diaphragm 815 is adapted to vibrate, and thus generate sound waves, in response to a drive signal applied to a voice coil 823 secured to the moveable portion of the hinged diaphragm 815. As seen in FIG. 8b, at least part of the hinged diaphragm 815 comprises an embossed part 819 for increasing the stiffness of the diaphragm and/or for providing an air venting path so that the air volume inside the magnetic motor can be vented. The magnetic motor comprises a permanent magnet 821 sandwiched between a centre yoke 822 and an outer yoke 820 which extends through an opening 827 in the housing part 814′. With this arrangement the overall height of the housing 814, 814′ can be significantly reduced. The centre yoke 822 and the outer yoke 8820 form an air gap within which at least part of the voice coil 823 is positioned. The hinged diaphragm 815 is hinged via one or more hinges 824 to a frame structure 826. The hinged diaphragm 815 and the frame structure 826 preferably form an integrated structure of the same material, such as metal including aluminium. The hinged diaphragm 815 and the frame structure 826 are separated by one or more openings which are at least partly filled with a flexible sealing member 825, such as a corrugated polymer film or a viscoelastic gel. With the flexible sealing member 825 applied in the one or more openings between the hinged diaphragm 815 and the frame structure 825, the front and rear volumes 817, 818 are acoustically sealed from each other.

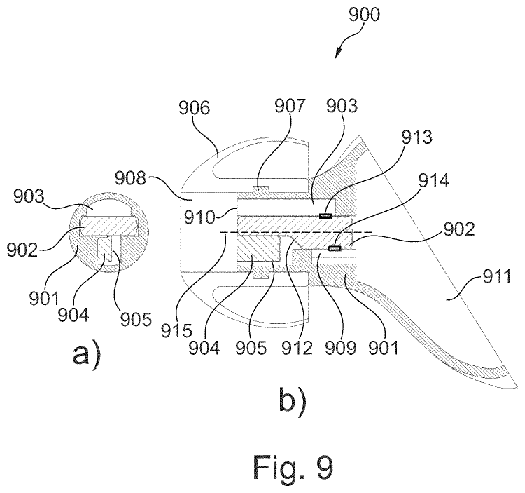

The embodiment of FIGS. 9a-b show an audio assembly 900 comprising a receiver 902 having an indentation 912 in the form of a narrow or thin receiver portion in order to provide space for a microphone 904. As it will be discussed in further details below the microphone 904 may comprise a MEMS cartridge comprising a pressure sensitive membrane extending in a plane being essentially perpendicular to a plane defined by a hinged diaphragm of the receiver 902 in order to minimize the sensitivity of the microphone to receiver induced vibrations. Similar to the previous embodiments, FIG. 9a is a cross-sectional view from the front of the assembly 900, whereas FIG. 9b is a cross-sectional view from the side of the audio assembly 900.

Thus, in FIG. 9b, the audio assembly 900 comprises a nozzle 901 having a sound channel and a sound port 908 acoustically connected to the sound channel. The sound channel has a longitudinal axis 915 extending in the longitudinal direction in FIG. 9b. A receiver 902 is at least partly positioned in the sound channel of the nozzle 901. The receiver 902 has a longitudinal axis that may coincide with longitudinal axis 915. The receiver 902 also comprises a sound output port 913, and the receiver 902 is maintained in position via press fitting from the nozzle 901. The receiver 902 further comprises an indentation 912 in the form of a narrow or thin receiver portion in order to provide space for the microphone 904 at least partly arranged in that indentation 912. As already mentioned, the microphone 904 may comprise a MEMS cartridge comprising a pressure sensitive membrane extending in a plane being essentially perpendicular to a plane defined by a hinged diaphragm of the receiver 902. In FIG. 9b the plane of the pressure sensitive membrane will be in the plane of the drawing. With this perpendicular arrangement the sensitivity of the microphone to receiver induced vibrations is minimized.

The microphone 904 is moreover arranged, at least partly, in a recess or pocket 905 in the nozzle 901. As depicted in FIG. 9b, the microphone 904 occupies a vast majority of the recess or pocket 905 in the longitudinal direction of the nozzle 901. The microphone 904 comprises a sound inlet port (not shown) that faces either towards the viewer or away from the viewer. Moreover, the microphone 904 is acoustically connected to an excess volume of the recess or pocket 905, wherein said excess volume is acoustically connected to the sound port 908 of the nozzle 901. Thus, audible sound that enters the sound port 908 of the nozzle 901 can be detected by the microphone 904.

In FIG. 9b, an acoustic passage 903 defining an acoustic mass exists between a part of a sound channel wall and an outer housing part of the receiver 902. The acoustic passage 903 extends in the direction of the longitudinal axis of the sound channel of the nozzle 901 which corresponds to the longitudinal direction in FIG. 9b. The acoustic passage 903 is, at one end, acoustically connected to the sound port of the nozzle 908 via the opening 910, and acoustically connected to the sound output port 913 of the receiver 902 at or near the other end. The acoustic passage 903 thus becomes arranged between the sound port of the nozzle 908 and the sound output port 913 of the receiver 502.

In FIG. 9b the audio assembly 900 further comprises a flexible dome 906 secured to the nozzle 901. The flexible dome 906, which is adapted to properly position the audio assembly in the ear canal of the user, is aligned with the nozzle 901 via the protrusion 907 which engages with a corresponding recess in the flexible dome 906. The nozzle 901 and the flexible dome 906 are fixated relative to each other via press fitting. A venting opening 914 of the receiver 902 is adapted to vent the rear volume of the receiver 902, and as seen in FIG. 9b, the venting opening 914 is acoustically connected to an external rear volume 911 via a venting channel 909 formed in the nozzle 901.

In FIG. 9a the nozzle 901, the receiver 902 and the microphone 904 are depicted from a front perspective of the audio assembly 900, i.e. from the sound port 908. As seen, the microphone 904 is rotated around 90 degrees with its sound inlet opening facing towards right, i.e. into the excess volume of the recess or pocket 905. In addition to the structural elements (the nozzle 901, the receiver 902, and the microphone 904) the acoustic passage 903 as well as the excess volume of the recess or pocket 905 are also depicted. As depicted in FIG. 9a, the indentation 912 in the form of a narrow or thin receiver portion extends the entire width of the receiver 902.

Again, the receiver 902 may be a moving coil type receiver where a voice coil is secured to a hinged diaphragm which is adapted to move when a drive signal is applied to the voice coil. In terms of performance the receiver 902 has a low-frequency output at 100 Hz (1 Vrms) at around 120 dB SPL, and a maximum output at the first resonance peak (around 2 kHz) at 122 dB SPL. The mechanical resonance frequency of the hinged diaphragm is around 15 kHz. The microphone 904 may be a MEMS microphone comprising a MEMS cartridge and a signal processor for processing signals from the MEMS cartridge. As already mentioned, the pressure sensitive membrane of the MEMS cartridge may extend in a plane being essentially perpendicular to a plane defined by a hinged diaphragm of the receiver 902. The MEMS microphone may be sensitive in the audible range, i.e. between 20 Hz and 20 KHz.

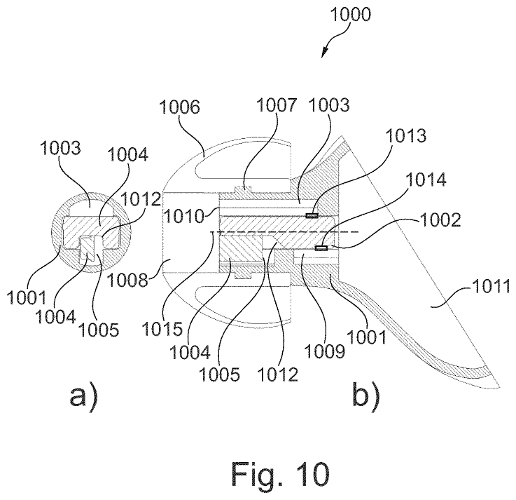

The embodiment of FIGS. 10a-b show an audio assembly 1000 comprising a receiver 1002 also having an indentation 1012 in the form of a narrow or thin receiver portion in order to provide space for a microphone 1004. However, in contrast to the embodiment of FIGS. 9a-b the narrow or thin receiver portion does not extend the entire width of the receiver 1002. As depicted in FIG. 10a, the indentation 1012 instead forms a pocket-like indentation. It is however still advantageous that the microphone 1004, that may comprise a MEMS cartridge comprising a pressure sensitive membrane, may be oriented in such a manner that the pressure sensitive membrane extends in a plane being essentially perpendicular to a plane defined by a hinged diaphragm of the receiver 1002 in order to minimize the sensitivity of the microphone 1004 to receiver induced vibrations. Similar to the previous embodiments, FIG. 10a is a cross-sectional view from the front of the assembly 1000, whereas FIG. 10b is a cross-sectional view from the side of the audio assembly 1000.

Thus, in FIG. 10b, the audio assembly 1000 comprises a nozzle 1001 having a sound channel and a sound port 1008 acoustically connected to the sound channel. The sound channel has a longitudinal axis 1015 extending in the longitudinal direction in FIG. 10b. The receiver 1002 is at least partly positioned in the sound channel of the nozzle 1001. The receiver 1002 has a longitudinal axis that may coincide with longitudinal axis 1015. The receiver 1002 comprises a sound output port 1013, and the receiver 1002 is maintained in position via press fitting from the nozzle 1001. The receiver 1002 further comprises the indentation 1012 in the form of a pocket in order to provide space for the microphone 1004 at least partly arranged in that pocket. As already discussed, the microphone 1004 may comprise a MEMS cartridge comprising a pressure sensitive membrane extending in a plane being essentially perpendicular to a plane defined by a hinged diaphragm of the receiver 1002. In FIG. 10b the plane of the pressure sensitive membrane will be in the plane of the drawing. With this perpendicular arrangement the sensitivity of the microphone to receiver induced vibrations is minimized.

The microphone 1004 is moreover arranged, at least partly, in a recess or pocket 1005 in the nozzle 1001. As depicted in FIG. 10b, the microphone 1004 occupies a vast majority of the recess or pocket 1005 in the longitudinal direction of the nozzle 1001. The microphone 1004 further comprises a sound inlet port (not shown) that faces either towards the viewer or away from the viewer in FIG. 10b. Moreover, the microphone 1004 is acoustically connected to an excess volume of the recess or pocket 1005, wherein said excess volume is acoustically connected to the sound port 1008 of the nozzle 1001. Thus, audible sound that enters the sound port 1008 of the nozzle 1001 can be detected by the microphone 1004.

In FIG. 10b, an acoustic passage 1003 defining an acoustic mass exists between a part of a sound channel wall and an outer housing part of the receiver 1002. The acoustic passage 1003 extends in the direction of the longitudinal axis of the sound channel of the nozzle 1001 which corresponds to the longitudinal direction in FIG. 10b. The acoustic passage 1003 is, at one end, acoustically connected to the sound port of the nozzle 1008 via the opening 1010, and acoustically connected to the sound output port 1013 of the receiver 1002 at or near the other end. The acoustic passage 1003 thus becomes arranged between the sound port of the nozzle 1008 and the sound output port 1013 of the receiver 1002.

In FIG. 10b the audio assembly 1000 further comprises a flexible dome 1006 secured to the nozzle 1001. The flexible dome 1006, which is adapted to properly position the audio assembly in the ear canal of the user, is aligned with the nozzle 1001 via the protrusion 1007 which engages with a corresponding recess in the flexible dome 1006. The nozzle 1001 and the flexible dome 1006 are fixated relative to each other via press fitting. A venting opening 1014 of the receiver 1002 is adapted to vent the rear volume of the receiver 1002, and as seen in FIG. 10b, the venting opening 1014 is acoustically connected to an external rear volume 1011 via a venting channel 1009 formed in the nozzle 1001.

In FIG. 10a the nozzle 1001, the receiver 1002 and the microphone 1004 are depicted from a front perspective of the audio assembly 1000, i.e. from the sound port 1008. As seen, the microphone 1004 is rotated around 90 degrees with its sound inlet opening facing towards right, i.e. into the excess volume of the recess or pocket 1005. In addition to the structural elements (the nozzle 1001, the receiver 1002, and the microphone 1004) the acoustic passage 1003 as well as the excess volume of the recess or pocket 1005 are also depicted.

Again, the receiver 1002 may be a moving coil type receiver where a voice coil is secured to a hinged diaphragm which is adapted to move when a drive signal is applied to the voice coil. In terms of performance the receiver 1002 has a low-frequency output at 100 Hz (1 Vrms) at around 120 dB SPL, and a maximum output at the first resonance peak (around 2 kHz) at 122 dB SPL. The mechanical resonance frequency of the hinged diaphragm is around 15 kHz. The microphone 1004 may be a MEMS microphone comprising a MEMS cartridge and a signal processor for processing signals from the MEMS cartridge. As already mentioned, the pressure sensitive membrane of the MEMS cartridge may extend in a plane being essentially perpendicular to a plane defined by a hinged diaphragm of the receiver 1002. The MEMS microphone may be sensitive in the audible range, i.e. between 20 Hz and 20 KHz.

The acoustic mass of the acoustic passage depicted in FIGS. 1-5 and 8-10 may be in the range 8000-30000 kg/m⁴, such as in the range 10000-25000 kg/m⁴. Moreover, in case the venting opening of the receiver comprises an acoustic filter element that forms an acoustic filter having an acoustic resistance, this acoustic filter may be an acoustic low-pass filter having an acoustic resistance in the range of 1-5 GPa. s/m³.

Although the present invention has been discussed in the foregoing with reference to exemplary embodiments of the invention, the invention is not restricted to these particular embodiments which can be varied in many ways without departing from the invention. The discussed exemplary embodiments shall therefore not be used to construe the appended claims strictly in accordance therewith. On the contrary, the embodiments are merely intended to explain the wording of the appended claims, without intent to limit the claims to these exemplary embodiments. The scope of protection of the invention shall therefore be construed in accordance with the appended claims only, wherein a possible ambiguity in the wording of the claims shall be resolved using these exemplary embodiments.

1. An audio assembly for a hearing device, said audio assembly comprising
1) a nozzle comprising a sound channel and a sound port acoustically connected to the sound channel, wherein the sound channel has a longitudinal axis,
2) a receiver at least partly positioned in the sound channel of the nozzle, wherein the receiver has a longitudinal axis, and wherein a housing of the receiver comprises a sound output port, and
3) a first microphone at least partly arranged in the nozzle, wherein the first microphone comprises a sound inlet port,
wherein the longitudinal axes of the sound channel and the receiver are essentially parallel when the receiver is at least partly positioned in the sound channel, and
wherein an acoustic passage defining an acoustic mass exists between a part of a sound channel wall and an outer housing part of the receiver, and wherein the acoustic passage extends in the direction of the longitudinal axis of the sound channel, and
wherein the acoustic passage is acoustically connected to the sound port of the nozzle and to the sound output port of the receiver whereby the acoustic passage is arranged between the sound port of the nozzle and the sound output port of the receiver.

2. An audio assembly according to claim 1, wherein at least part of the sound port of the nozzle forms a sound inlet for the first microphone, and wherein that part of sound port of the nozzle is acoustically connected to the sound inlet port of the first microphone.

3. An audio assembly according to claim 1, wherein the first microphone is at least partly arranged in the housing of the receiver.

4. An audio assembly according to claim 1, wherein the housing of the receiver comprises a depression, indentation, recess or pocket, and wherein the first microphone is at least partly arranged in said depression, indentation, recess or pocket.

5. An audio assembly according to claim 1, wherein the first microphone is at least partly positioned in the acoustic passage, and wherein at least part of the sound port of the nozzle forms a sound inlet which is acoustically connected to the sound inlet port of the first microphone.

6. An audio assembly according to claim 5, further comprising a second microphone comprising a sound inlet port, wherein at least part of the sound port of the nozzle forms a sound inlet for the second microphone, and wherein the sound inlet is acoustically connected to the sound inlet port of the second microphone.

7. An audio assembly according to claim 6, wherein the first microphone is adapted to measure sound pressure in the acoustic passage, and wherein the second microphone is adapted to measure sound pressure in the ear canal.

8. An audio assembly according to claim 6, wherein the first and/or the second microphone is/are at least partly arranged in the housing of the receiver.

9. An audio assembly according to claim 1, wherein the receiver has an oblong shape along its longitudinal axis, and wherein the sound output port of the receiver is arranged in a first oblong housing part being essentially parallel to the longitudinal axis of the receiver.

10. An audio assembly according to claim 9, wherein a venting opening of the receiver is arranged in a second oblong housing part being essentially parallel to the longitudinal axis of the receiver, and wherein the venting opening is adapted to vent a rear volume of the receiver.

11. An audio assembly according to claim 10, wherein the venting opening comprises an acoustic filter element forming an acoustic filter having an acoustic resistance, such as an acoustic low-pass filter having an acoustic resistance in the range of 1-5 GPa·s/m³.

12. An audio assembly according to claim 1, wherein the acoustic mass of the acoustic passage is in the range 8000-30000 kg/m⁴, such as in the range 10000-25000 kg/m⁴.

13. An audio assembly according to claim 1, wherein the receiver comprises a hinged diaphragm and a voice coil secured thereto, and wherein the hinged diaphragm is adapted to deflect in response to a drive signal applied to the voice coil.

14. An audio assembly according to claim 13, wherein the first and/or second microphone(s) comprise(s) a MEMS cartridge comprising a pressure sensitive membrane, said pressure sensitive membrane(s) extending in a plane being essentially perpendicular to a plane defined by the hinged diaphragm of the receiver in order to minimize the sensitivity of first and/or second microphone(s) to receiver induced vibrations.

15. An audio assembly for a hearing device, said audio assembly comprising
1) a nozzle having a longitudinal axis and comprising sound port,
2) a receiver at least partly positioned in the nozzle, wherein the receiver has a longitudinal axis, and wherein a housing of the receiver comprises a sound output port acoustically connected to the sound port of the nozzle, and
3) a first microphone at least partly arranged in the nozzle, wherein the first microphone comprises a sound inlet port acoustically connected to the sound port of the nozzle,
wherein the longitudinal axes of the nozzle and the receiver are essentially parallel when the receiver is at least partly positioned in the nozzle, and wherein the receiver comprises a hinged diaphragm and a voice coil secured thereto, and wherein the hinged diaphragm is adapted to deflect in response to a drive signal applied to the voice coil.

16. A hearing device comprising an audio assembly according to claim 1.
